(19) United States
(12) Patent Application Publication
(10) Pub. No.: US 2013/0135334 A1
(43) Pub. Date: May 30, 2013

(54) IMAGE PROCESSING APPARATUS, STORAGE MEDIUM FOR STORING CONTROL PROGRAM, AND CONTROLLING METHOD FOR IMAGE PROCESSING APPARATUS

(71) Applicant: Kazuyasu Ohwaki, Ome-shi (JP)

(72) Inventor: Kazuyasu Ohwaki, Ome-shi (JP)

(21) Appl. No.: 13/606,483

(22) Filed: Sep. 7, 2012

(30) Foreign Application Priority Data
Nov. 30, 2011 (JP) 2011-262315

(51) Int. Cl. G09G 5/02

(52) U.S. Cl. 345/589

(57) ABSTRACT

According to one embodiment, image processing apparatus includes, sensor configured to acquire first brightness data, receiver configured to receive second brightness data, correction coefficient calculator configured to calculate correction coefficient based on first brightness data and second brightness data, parameter calculator configured to calculate parameter based on first brightness data and correction coefficient, controller configured to control brightness controlling signal according to brightness value corresponding to parameter, and output module configured to output brightness controlling signal.

### CROSS-REFERENCE TO RELATED APPLICATIONS

This application is based upon and claims the benefit of priority from Japanese Patent Application No. 2011-262315, filed Nov. 30, 2011, the entire contents of which are incorporated herein by reference.

### FIELD

Embodiments described herein relate generally to image processing apparatus, storage medium for storing control program, and controlling method for image processing apparatus.

### BACKGROUND

Conventionally, electronic apparatuses such as an image processing apparatus capable of playing video contents such as movies, television programs, and games have been widely used in general.

The image processing apparatus outputs a video signal and a brightness controlling signal to a liquid crystal display device including, for example, a liquid crystal display panel having multiple pixels arranged in a matrix form and a backlight for illuminating this liquid crystal panel. The liquid crystal display device controls illumination level of each pixel by applying a voltage to each pixel of the liquid crystal display panel according to the video signal. The liquid crystal display device controls the brightness of the backlight according to the brightness controlling signal. Thus, the image processing apparatus can display a video on the liquid crystal display device.

The image processing apparatus includes sensors such as an illumination sensor or a color sensor. The image processing apparatus uses the sensor to obtain information about the brightness of a room in which the image processing apparatus is installed, and controls image quality such as brightness of video according to the obtained brightness data. For example, the sensor is provided on the front surface of the image processing apparatus or the liquid crystal display device. Accordingly, the sensor obtains (brightness) information at the position of the viewer from the view point of the image processing apparatus or the liquid crystal display device.

However, the viewer faces the liquid crystal display device. For this reason, the image processing apparatus needs to control the image quality such as the brightness of the video according to the brightness data representing a case where the liquid crystal display device is seen from the viewer.

For example, the brightness data at the position of the liquid crystal display device may be obtained by attaching a sensor to a remote controller. However, the brightness of the room changes moment by moment, and therefore, in order to control the brightness to an appropriate level, it is necessary to constantly obtain the brightness data from the remote controller. For this reason, there is a problem in that the remote controller is always required to be placed to face the liquid crystal display device. Moreover, since the brightness data are constantly obtained by the remote controller, there is a problem in that the remote controller consumes much power.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing an image processing apparatus according to an embodiment.

FIG. 2 is an exemplary view showing the image processing apparatus according to the embodiment.

FIG. 3 is an exemplary view showing the image processing apparatus according to the embodiment.

FIG. 4 is an exemplary view showing the image processing apparatus according to the embodiment.

FIG. 5 is an exemplary view showing the image processing apparatus according to the embodiment.

FIG. 6 is an exemplary view showing the image processing apparatus according to the embodiment.

FIG. 7 is an exemplary view showing the image processing apparatus according to the embodiment.

### DETAILED DESCRIPTION

Various embodiments will be described hereinafter with reference to the accompanying drawings. In general, according to one embodiment, an image processing apparatus outputting a brightness controlling signal with which a brightness of a display device is controlled, the image processing apparatus comprises, a sensor configured to acquire first brightness data, a receiver configured to receive second brightness data, a correction coefficient calculator configured to calculate a correction coefficient based on the first brightness data and the second brightness data, a parameter calculator configured to calculate a parameter based on the first brightness data and the correction coefficient, a controller configured to control a brightness controlling signal according to a brightness value corresponding to the parameter, and an output module configured to output the brightness controlling signal.

Hereinafter, an image processing apparatus, a storage medium for storing a control program, and a controlling method for the image processing apparatus according to an embodiment will be explained in detail with reference to drawings.

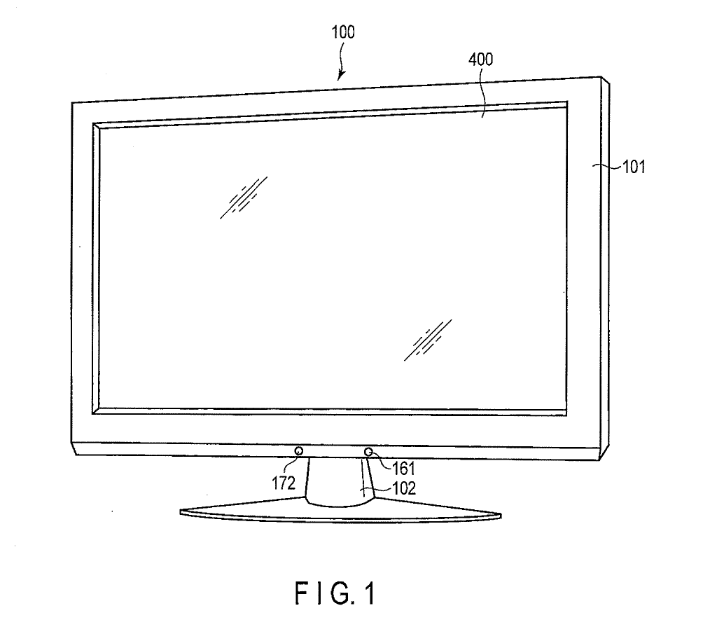

FIG. 1 illustrates an example of external appearance of a broadcast receiving apparatus 100 serving as an image processing apparatus according to an embodiment.

The broadcast receiving apparatus 100 includes a main body 101 provided with a display (display 400) for displaying video and a foot portion 102 for supporting the main body 101 in such a manner that it can stand on its own.

The main body 101 is provided with a communication module 161 receiving an operation signal emitted from a remote controller and the like and an image acquire module 172 acquiring brightness data.

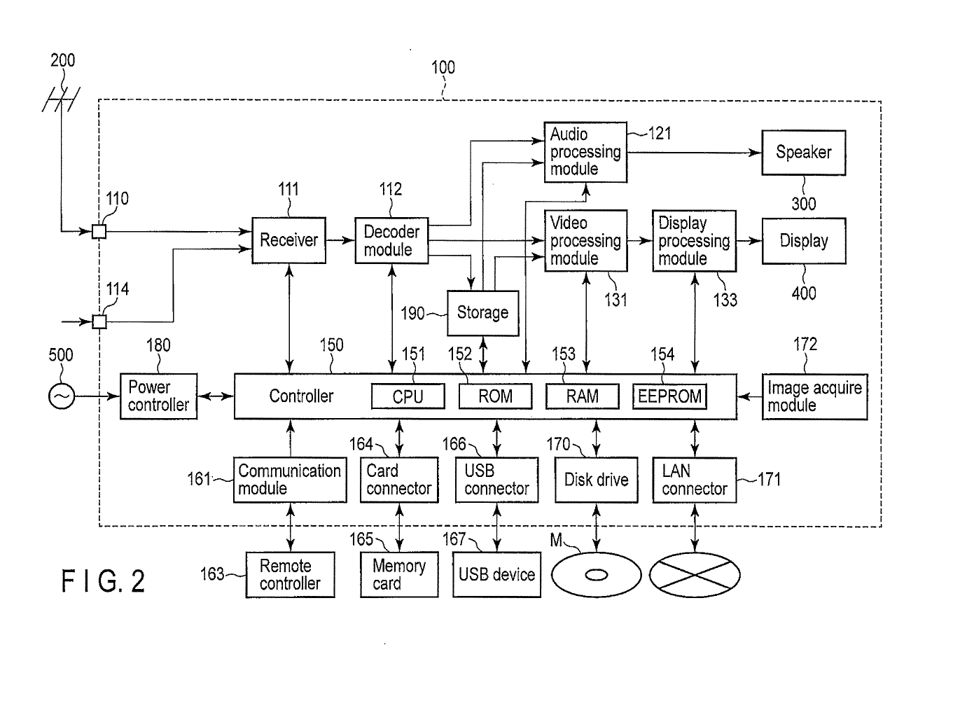

FIG. 2 illustrates an example of the broadcast receiving apparatus 100.

In addition, the broadcast receiving apparatus 100 includes a broadcast input terminal 110, a receiver 111, a decoder module 112, a communication interface 114, an audio processing module 121, a video processing module 131, a display processing module 133, a controller 150, a communication module 161, a card connector 164, a USB connector 166, a disk drive 170, a LAN connector 171, an image acquire module 172, a power controller 180, and a storage 190. In addition, the broadcast receiving apparatus 100 includes a speaker 300 and a display 400.

The broadcast input terminal 110 is, for example, an input terminal to which a digital broadcast signal received by an antenna 200 is input. The antenna 200 receives, for example, a digital terrestrial broadcast signal, a BS (broadcasting satellite) digital broadcast signal, and/or, a 110-degrees CS (communication satellite) digital broadcast signal. In other words, the broadcast input terminal 110 receives contents such as programs provided by broadcast signals.

The broadcast input terminal 110 provides the received digital broadcast signal to the receiver 111. The receiver 111 is a receiver for digital broadcast signals. The receiver 111 tunes in to (selects) a digital broadcast signal provided from the antenna 200. The receiver 111 transmits the digital broadcast signal, to which the receiver 111 tunes in to, to the decoder module 112. When the signal provided from the broadcast input terminal 110 or the communication interface 114 is an analog signal, the receiver 111 converts the signal into a digital signal.

The decoder module 112 demodulates the received digital broadcast signal. Further, the decoder module 112 performs signal processing on the demodulated digital broadcast signal (content). As a result, the decoder module 112 decodes a video signal, an audio signal, and other data signals from the digital broadcast signal. For example, the decoder module 112 decodes a transport stream (TS), in which the video signal, the audio signal, the other data signals, and the like, are multiplexed, from the digital broadcast signal.

The decoder module 112 provides the audio signal to the audio processing module 121. In addition, the decoder module 112 provides the video signal to the video processing module 131. Further, the decoder module 112 provides a data signal to the controller 150. In other words, the antenna 200, the receiver 111, and the decoder module 112 function as a receiver configured to receive a content.

The communication interface 114 includes one of or a plurality of interfaces capable of receiving a content, such as an HDMI (High Definition Multimedia Interface) (registered trademark) terminal, an audio input terminal, an S-video terminal, a component video terminal, a D video terminal, a D-Sub terminal, and a DVI-I terminal. The communication interface 114 receives, from another apparatus, a content in which a digital video signal, a digital audio signal, and the like are multiplexed. The communication interface 114 provides the digital signal (content), received from another apparatus, to the receiver 111. The communication interface 114 provides a content, received from another apparatus, to the decoder module 112. In other words, the communication interface 114 functions as a receiver configured to receive a content.

The decoder module 112 performs signal processing on a content provided from the communication interface 114 via the receiver 111. For example, the decoder module 112 separates the digital signal into a digital video signal, a digital audio signal, and a data signal. The decoder module 112 provides the digital audio signal to the audio processing module 121. Further, the decoder module 112 provides the digital video signal to the video processing module 131. Further, the decoder module 112 provides other information about a content to the controller 150.

Furthermore, the decoder module 112 provides the content to the storage 190 explained later based on control of the controller 150. The storage 190 stores the provided content. Therefore, the broadcast receiving apparatus 100 can record the content.

The audio processing module 121 converts the digital audio signal received from the decoder module 112 into a signal (audio signal) in a format that can be reproduced by the speaker 300. The audio processing module 121 provides the audio signal to the speaker 300. The speaker 300 plays sound based on the provided audio signal.

The video processing module 131 converts the digital video signal received from the decoder module 112 into a video signal in a format that can be reproduced by the display 400. In other words, the video processing module 131 decodes (reproduces) the video signal received from the decoder module 112 and makes it into a video signal in a format that can be reproduced by the display 400. Further, the video processing module 131 superimposes an OSD signal, provided from an OSD processing module not shown, onto the video signal. The video processing module 131 outputs the video signal to the display processing module 133.

The OSD processing module generates an OSD signal for superimposing and displaying a GUI (graphic user interface) screen, subtitles, a time, other information, or the like onto a screen based on the data signal provided by the decoder module 112 and/or the control signal provided by the controller 150. The OSD processing module may be provided separately as a module in the broadcast receiving apparatus 100, or may be provided as a function of the controller 150.

For example, the display processing module 133 performs color, brightness, sharpness, contrast, or other image quality adjusting processing on the received video signal based on the control of the controller 150. The display processing module 133 provides the video signal, of which image quality has been adjusted, to the display 400. The display 400 displays the video based on the video signal provided.

The display processing module 133 also generates a brightness controlling signal. For example, the display processing module 133 generates a brightness controlling signal based on the brightness of the received video signal and the control of the controller 150. The display processing module 133 controls the brightness of the backlight of the display 400 according to the brightness controlling signal. Therefore, the broadcast receiving apparatus 100 can appropriately control the brightness of the display 400.

The display 400 includes a liquid crystal display device including, for example, a liquid crystal display panel having multiple pixels arranged in a matrix form and a backlight for illuminating this liquid crystal panel. The display 400 displays a video based on the video signal provided from the broadcast receiving apparatus 100.

Instead of the display 400, the broadcast receiving apparatus 100 may be configured to have a video output terminal. Instead of the speaker, the broadcast receiving apparatus 100 may be configured to have an audio output terminal. In this case, the broadcast receiving apparatus 100 outputs the video signal and the brightness controlling signal to a display device connected to the video output terminal, and outputs an audio signal to a speaker connected to the audio output terminal. Therefore, the broadcast receiving apparatus 100 can cause the display device to display the video and can cause the speaker to output the audio.

The controller 150 functions as a controller configured to control operation of each module of the broadcast receiving apparatus 100. The controller 150 includes a CPU 151, a ROM 152, a RAM 153, an EEPROM 154, and the like. The controller 150 performs various kinds of processing based on an operation signal provided from the communication module 161 or an operation module, not shown.

The CPU 151 has operation devices and the like executing various kinds of operation processing. The CPU 151 achieves various kinds of functions by executing programs stored in the ROM 152, the EEPROM 154, or the like.

The ROM 152 stores programs for achieving various kinds of functions, programs for controlling the broadcast receiving apparatus 100, and the like. The CPU 151 activates programs stored in the ROM 152 based on an operation signal provided by the communication module 161. Accordingly, the controller 150 controls operation of each module.

The RAM 153 functions as a work memory of the CPU 151. In other words, the RAM 153 stores results of operation of the CPU 151, data read by the CPU 151, and the like.

The EEPROM 154 is a nonvolatile memory storing various kinds of setting information, programs, and the like.

For example, the communication module 161 may be configured to have a sensor and the like receiving an operation signal transmitted from a remote controller 163 via wireless communication. The communication module 161 may be configured to receive a signal provided by an operation key, a keyboard, a mouse, an audio input device, a touch pad, or the like, serving as another operation module. Furthermore, the communication module 161 may be configured to transmit a signal to the remote controller 163 or another module via wireless communication. In other words, the communication module 161 functions as a communication module configured to transmit and receive the operation signal, other information, or the like.

The communication module 161 provides the received operation signal to the controller 150. The controller 150 causes the broadcast receiving apparatus 100 to perform various kinds of processing based on the operation signal provided from the communication module 161.

It should be noted that the touch pad includes a device generating position information based on an electrostatic sensor, a thermo sensor, or other methods. When the broadcast receiving apparatus 100 includes the display 400, the communication module 161 may be configured to receive a signal from a touch panel and the like integrally formed with the display 400.

The remote controller 163 generates an operation signal based on user's input. The remote controller 163 transmits the generated operation signal to a sensor of the communication module 161 via infrared communication. It should be noted that the sensor and the remote controller 163 may be configured to transmit and receive the operation signal via other wireless communication such as radio wave.

For example, the card connector 164 is an interface for communicating with a memory card 165 storing a motion picture content. The card connector 164 reads content data of motion pictures from the connected memory card 165, and provides the content data to the controller 150.

The USB connector 166 is an interface for communicating with a USB device 167. The USB connector 166 provides the signal, provided from the connected USB device 167, to the controller 150.

For example, when the USB device 167 is an operation input device such as a keyboard, the USB connector 166 receives the operation signal from the USB device 167. The USB connector 166 provides the received operation signal to the controller 150. In this case, the controller 150 executes various kinds of processing based on the operation signal provided from the USB connector 166.

For example, when the USB device 167 is a storage device storing content data of motion pictures, the USB connector 166 can obtain the content from the USB device 167. The USB connector 166 provides the obtained content to the controller 150.

The disk drive 170 has a drive capable of loading, for example, a compact disc (CD), a digital versatile disk (DVD), a Blu-ray Disc (registered trademark), or other optical disks M capable of recording content data of motion pictures. The disk drive 170 reads the content from the loaded optical disk M, and provides the read content to the controller 150.

The LAN connector 171 is an interface for connecting the broadcast receiving apparatus 100 to a network. The controller 150 can download and upload various kinds of data via the network when the LAN connector 171 is connected to a public circuit by way of a LAN cable, a wireless LAN, or the like.

The power controller 180 controls supply of electric power to each module of the broadcast receiving apparatus 100. The power controller 180 receives electric power from a commercial power supply 500 via, for example, an AC adapter. The commercial power supply 500 provides electric power of an alternate current to the power controller 180. The power controller 180 converts the received electric power of the alternate current into a direct current and provides the direct current to each module.

In addition, the broadcast receiving apparatus 100 may further include other interfaces. An example of interface includes Serial-ATA. The broadcast receiving apparatus 100 can obtain a content recorded in the device connected via the interface and reproduce the content. The broadcast receiving apparatus 100 can output the reproduced audio signal and video signal to the device connected via the interface.

When the broadcast receiving apparatus 100 is connected to a network via the interface, the broadcast receiving apparatus 100 can acquire content data of motion pictures on the network, and reproduce the content data.

The storage 190 is a storage device storing the content. The storage 190 includes a large-capacity storage device such as a hard disk (HDD), a solid state drive (SSD), or a semiconductor memory. The storage 190 may be constituted by a storage device connected to the USB connector 166, the LAN connector 171, the communication interface 114, or other interfaces.

As described above, when a content is recorded, the controller 150 inputs data of a content demodulated by the decoder module 112 to the storage 190. Further, the controller 150 gives the storage 190 an address at which the content is stored in the storage 190. The storage 190 stores the content, provided from the decoder module 112, at an address given by the controller 150.

It should be noted that the storage 190 may be configured to store a TS which is decoded from a digital broadcast signal, or may be configured to store a compressed content obtained by compressing the TS according to AVI, MPEG, or other compression methods.

The controller 150 can read and reproduce the content stored in the storage 190. For example, the controller 150 gives an instruction of an address of the storage 190 to the storage 190. The storage 190 reads the content from the address given by the controller 150. The storage 190 provides the read content to the audio processing module 121, the video processing module 131, the controller 150, and the like. Therefore, the broadcast receiving apparatus 100 can reproduce the recorded content.

It should be noted that the broadcast receiving apparatus 100 includes multiple receivers 111 and multiple decoder modules 112. Accordingly, the broadcast receiving apparatus 100 can receive multiple contents at a time, and can decode the multiple received contents at a time. Therefore, the broadcast receiving apparatus 100 can obtain multiple pieces of reproducible content data at a time. In other words, the broadcast receiving apparatus 100 can record multiple contents at a time.

The image acquire module 172 includes a sensor provided in the display 400. The image acquire module 172 includes, for example, a CCD sensor, a CMOS sensor, a photodiode, or other sensors capable of detecting the brightness. The image acquire module 172 receives light in a predetermined range, and converts the received light into an electric signal, thus acquiring brightness data representing the brightness (first brightness data LT). The image acquire module 172 provides the acquired first brightness data LT to the controller 150.

For example, the image acquire module 172 acquires the image in the predetermined range, and calculates the first brightness data LT based on the values of the pixels in the acquired image. For example, the image acquire module 172 may be configured to calculate one value according to the received light to calculate the first brightness data LT. For example, as shown in FIG. 1, the image acquire module 172 is provided on the front surface of the main body 101 like the display 400. In this case, the image acquire module 172 can acquire the brightness data representing the brightness at the position of the user when it is seen from the display 400. In other words, the image acquire module 172 acquired the first brightness data according to the light received in the same direction as the display panel of the display device.

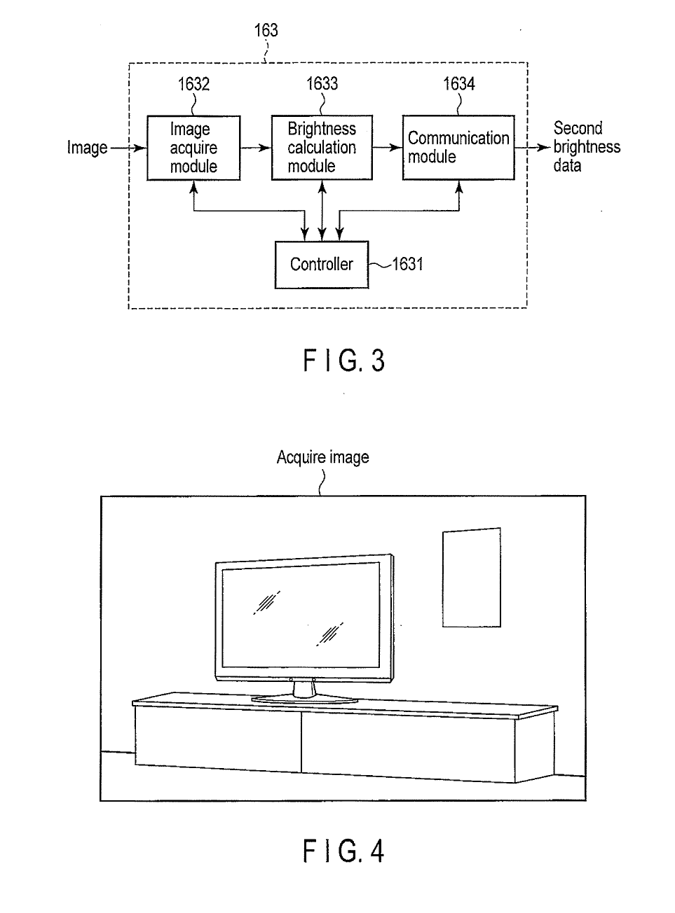

FIG. 3 illustrates an example of the remote controller 163.

As described above, the remote controller 163 generates an operation signal based on user's input, and provides the operation signal to the broadcast receiving apparatus 100. Further, the remote controller 163 acquires second brightness data LH, and provides the second brightness data LH to the broadcast receiving apparatus 100.

For example, the remote controller 163 includes a controller 1631, an image acquire module 1632, a brightness calculation module 1633, and a communication module 1634. Furthermore, the remote controller 163 may include an operation module receiving operation performed by the user who manipulates the remote controller 163.

The controller 1631 controls operation of the image acquire module 1632, the brightness calculation module 1633, and the communication module 1634. The controller 1631 controls operation of each module according to input. The controller 1631 may also be configured to control each module according to a control signal received from the broadcast receiving apparatus 100 by the communication module 1634.

For example, the image acquire module 1632 includes a CCD sensor, a CMOS sensor, a photodiode, or other sensors capable of detecting the brightness. The image acquire module 1632 receives light in a predetermined range, and converts the received signal into an electric signal. The image acquire module 1632 provides the electric signal to the brightness calculation module 1633.

The brightness calculation module 1633 calculates the brightness data representing the brightness (the second brightness data LH) according to the electric signal provided from the image acquire module 1632. The brightness calculation module 1633 provides the calculated second brightness data LH to the communication module 1634.

The communication module 1634 transmits the second brightness data LH to the broadcast receiving apparatus 100. For example, the communication module 1634 transmits the second brightness data LH to the communication module 161 of the broadcast receiving apparatus 100 via wireless communication. The communication module 161 provides the received second brightness data LH to the controller 150.

For example, the image acquire module 1632 acquires the image in the predetermined range. The brightness calculation module 1633 calculates the second brightness data LH based on the values of the pixels in the acquired image.

For example, the image acquire module 1632 acquires an image as shown in FIG. 4. In a typical case, the remote controller 163 is likely to be used to face the display 400. For this reason, the image acquire module 1632 installed in the remote controller 163 can receive light from the display 400 and a region therearound, and can acquire the image. In other words, the image acquire module 1632 can acquire the image at the position of the display 400 from the view point of the viewer.

For example, the brightness calculation module 1633 calculates, as the second brightness data LH, an average value of the values of the respective pixels in the image provided by the image acquire module 1632. Alternatively, the brightness calculation module 1633 may be configured to calculate, as the second brightness data LH, an intermediate value of the values of the respective pixels in the image provided from the image acquire module 1632. Alternatively, the brightness calculation module 1633 may be configured to calculate a histogram of the image provided from the image acquire module 1632, and calculate the second brightness data LH according to the calculated histogram. Furthermore, the brightness calculation module 1633 may be configured to calculate the second brightness data LH from the image according to other methods.

As described above, the remote controller 163 can calculate the second brightness data according to the light received in a direction opposite to the display panel of the display device.

Furthermore, the brightness calculation module 1633 may be configured to calculate the second brightness data LH based on the values of the pixels in a predetermined range in the image provided from the image acquire module 1632. For this reason, the brightness calculation module 1633 divides the image, provided from the image acquire module 1632, into multiple regions.

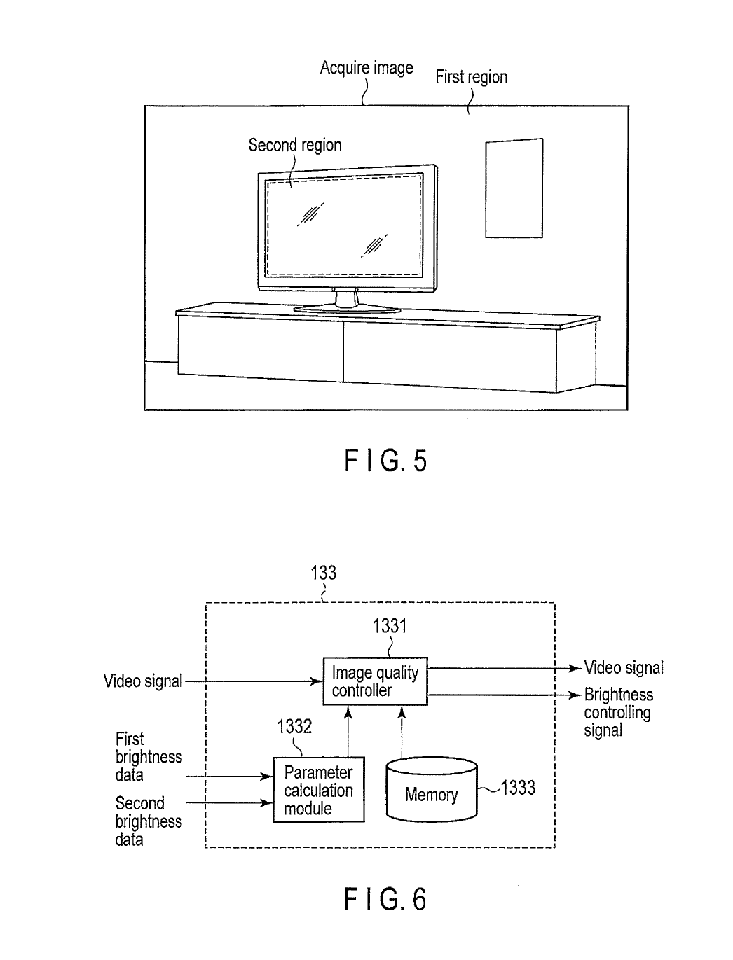

FIG. 5 illustrates an example where the image provided from the image acquire module 1632 is divided into multiple regions. For example, as shown in FIG. 5, the brightness calculation module 1633 divides the region of the display 400 of the broadcast receiving apparatus 100 and the region other than the region of the display 400. It should be noted that the region not including the display 400 in the image provided from the image acquire module 1632 is denoted as a first region, and the region of the display 400 is denoted as a second region.

For example, the brightness calculation module 1633 recognizes the second region based on the pattern displayed on the display 400. In this case, the broadcast receiving apparatus 100 causes the display 400 to display a predetermined test pattern. The brightness calculation module 1633 recognizes the predetermined test pattern from the image, thus capable of recognizing the second region.

The brightness calculation module 1633 may be configured to recognize, as the second region, a region in the image of which brightness is equal to or more than a predetermined brightness. Alternatively, when the brightness of the display 400 is known in advance, the brightness calculation module 1633 may be configured to recognize, as the second region, the region having the predetermined brightness in the image.

For example, the brightness calculation module 1633 calculates the second brightness data LH according to the above method based on the values of the pixels in the first region. Therefore, the brightness of the display 400 can be prevented from affecting the second brightness data LH. In other words, the brightness calculation module 1633 can extract a region not including the display panel from the taken image in the range including the display panel of the display device, and calculate the second brightness data from the image in the extracted region.

It should be noted that the brightness calculation module 1633 may be configured to further divide, as the second region, a range in which a window frame or a lighting device appear. Therefore, an extremely bright element can be prevented from affecting the second brightness data LH.

The controller 1631 performs calculation of calculating the second brightness data LH according to input. In other words, the controller 1631 acquires the image using the image acquire module 1632 according to input. The brightness calculation module 1633 calculates the second brightness data LH based on the image acquired by the image acquire module 1632.

The controller 150 of the broadcast receiving apparatus 100 provides the first brightness data LT, provided from the image acquire module 172, and the second brightness data LH, provided from the communication module 161, to the display processing module 133.

The display processing module 133 adjusts the video signal and controls the brightness controlling signal based on the control of the controller 150, the first brightness data LT, and the second brightness data LH.

FIG. 6 is an example of the display processing module 133.

The display processing module 133 includes an image quality controller 1331, a parameter calculation module 1332, and a memory 1333.

The image quality controller 1331 controls the image quality of the video signal provided from the video processing module 131 based on a parameter P that is output from the parameter calculation module 1332 and the control signal provided from the controller 150. For example, the image quality controller 1331 performs adjusting processing of the color of the video signal, the brightness, the sharpness, the contrast, or other image qualities.

The image quality controller 1331 generates the brightness controlling signal based on the parameter P, the control signal, and the video signal. When brightness controlling signal is provided from the video processing module 131, the image quality controller 1331 adjusts the brightness controlling signal based on the parameter P, the control signal, and the video signal.

The parameter calculation module 1332 calculates the parameter P based on the first brightness data LT and the second brightness data LH. The parameter calculation module 1332 provides the calculated parameter P to the image quality controller 1331.

The memory 1333 stores the parameter P and a value for adjusting or generating the brightness controlling signal (brightness value) in association with each other. When the memory 1333 receives the value of the parameter P from the image quality controller 1331, the memory 1333 provides the brightness value corresponding to the parameter P to the image quality controller 1331.

The image quality controller 1331 generates the brightness controlling signal according to the brightness value provided from the memory 1333. As described above, the image quality controller 1331 may be configured to adjust the brightness controlling signal provided from the video processing module 131, according to the brightness value provided from the memory 1333. The image quality controller 1331 outputs the brightness controlling signal. Therefore, the broadcast receiving apparatus 100 provides the brightness controlling signal to the display 400.

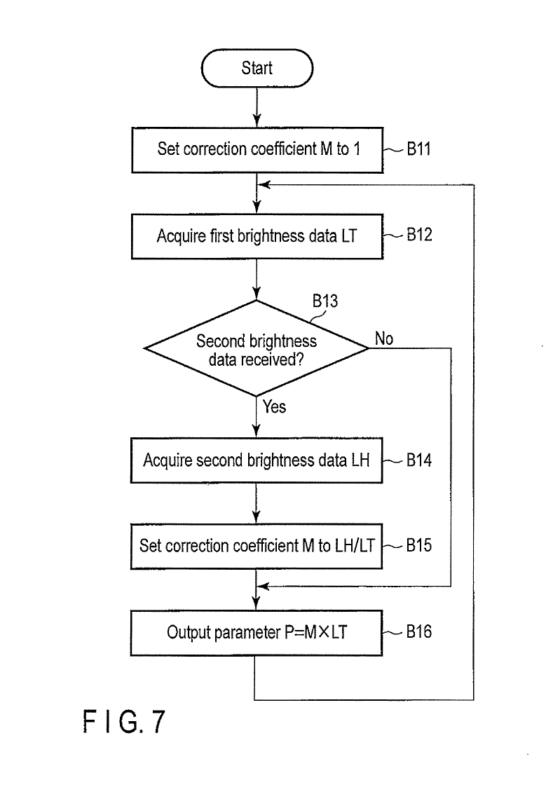

FIG. 7 illustrates an example of processing of the parameter calculation module 1332.

The parameter calculation module 1332 receives the first brightness data LT and the second brightness data LH. The parameter calculation module 1332 calculates the parameter P based on the first brightness data LT and the second brightness data LH which have been received. Specifically, the parameter calculation module 1332 calculates a correction coefficient M based on the first brightness data LT and the second brightness data LH, corrects the first brightness data LT using this correction coefficient M, and calculates the parameter P.

In block B11, the parameter calculation module 1332 sets the correction coefficient M to an initial value, 1. The parameter calculation module 1332 includes a memory and the like for storing this correction coefficient M. The parameter calculation module 1332 stores “1” to this memory as the value of the correction coefficient M.

In block B12, the parameter calculation module 1332 acquires the first brightness data LT. In block B13, the parameter calculation module 1332 determines whether the second brightness data LH are provided or not.

When it is determined that the second brightness data LH have been provided, the parameter calculation module 1332 acquires the second brightness data LH in block B14. Therefore, the parameter calculation module 1332 can acquire the first brightness data LT and the second brightness data LH.

In block B15, the parameter calculation module 1332 calculates the correction coefficient M by dividing the second brightness data LH by the first brightness data LT. In other words, for example, the correction coefficient M is calculated as follows: M=LH/LT. The parameter calculation module 1332 stores “LH/LT” to the memory as the calculated value of the correction coefficient M. Therefore, a new value is set to the correction coefficient M.

In block B16, the parameter calculation module 1332 calculates the parameter P using the correction coefficient M and the first brightness data LT. For example, the parameter P is calculated as follows: P=M×LT. The parameter calculation module 1332 provides the calculated parameter P to the image quality controller 1331. Further, the parameter calculation module 1332 proceeds to processing in block B12.

In other words, the parameter calculation module 1332 calculates the parameter P based on a ratio between the first brightness data LT, which is acquired by the image acquire module 172 and which is directed from the display 400 to the user, and the second brightness data LH, which is acquired by the image acquire module 1632 and which is directed from the side of the user to the display 400. The ratio between the first brightness data LT and the second brightness data LH represents the characteristics of the brightness of the room in which the display 400 is installed.

The parameter calculation module 1332 can generate or adjust the brightness controlling signal for multiple frames using the correction coefficient M calculated from the above processing. As a result, even when the second brightness data are not successively input, the image quality controller 1331 can generate or adjust the brightness controlling signal according to the characteristics of the brightness of the room. In other words, even when the brightness of the room changes as the time passes, the brightness controlling signal can be controlled without receiving the second brightness data LH from the remote controller 163.

As a result, an image processing apparatus, a storage medium for storing a control program, and a controlling method for the image processing apparatus can be provided that can control the brightness with easy processing.

It is not necessary for the remote controller 163 to acquire and transmit the second brightness data LH in order. For this reason, the electric power consumed by the remote controller 163 can be reduced.

The brightness of the room in which the display 400 is installed may change quickly when, e.g., a curtain is opened or closed or a lighting device is turned on. Furthermore, a window and the like may exist behind the display 400, and the first brightness data LT may be smaller than the second brightness data LH. In this case, the display 400 may not display at an appropriate level of brightness.

Therefore, the broadcast receiving apparatus 100 may be configured to successively acquire the first brightness data LT from the image acquire module 172, and when the first brightness data LT changes quickly, the broadcast receiving apparatus 100 may be configured to acquire the second brightness data LH and cause the display 400 to display. In this case, the user checks the display, and the user manipulates the remote controller 163, so that the second brightness data LH are input to the broadcast receiving apparatus 100 again. As a result, the broadcast receiving apparatus 100 can adjust the brightness controlling signal according to the brightness of the room after the change.

When the first brightness data LT changes quickly, the broadcast receiving apparatus 100 may be configured to adjust the brightness controlling signal according to a default value defined in advance. For example, in this case, the parameter calculation module 1332 sets the correction coefficient M to the initial value “1”, and calculates the parameter P based on the first brightness data LT and the correction coefficient M set in advance. Therefore, this can prevent quick change of the brightness of the display 400.

The default value of the correction coefficient M may be set for each time period. For example, the parameter calculation module 1332 may be configured to learn the value of the correction coefficient M for each time period based on a calculation result of a correction coefficient M in the past. Therefore, the parameter calculation module 1332 can learn the characteristics of the brightness of the room for each time period. As a result, the display processing module 133 can calculate an appropriate value of the brightness controlling signal.

When the first brightness data LT is less than the second brightness data LH, the broadcast receiving apparatus 100 may be configured to adjust the brightness controlling signal according to the default value defined in advance. Therefore, this can prevent quick change of the brightness of the display 400.

In the above-described embodiment, the remote controller 163 is explained as a remote device for manipulating the broadcast receiving apparatus 100, but the embodiment is not limited thereto. The remote controller 163 may be configured to include anything as long as the remote controller 163 includes at least a module for acquiring the second brightness data LH and a module for transmitting the acquired second brightness data LH to the broadcast receiving apparatus 100.

For example, the remote controller 163 may be constituted by a portable telephone, a portable information terminal, or the like including functions of a camera, infrared communication, wireless LAN, and the like.

Functions described in the above embodiment may be constituted not only with use of hardware but also with use of software, for example, by making a computer read a program which describes the functions. Alternatively, the functions each may be constituted by appropriately selecting either software or hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus outputting a brightness controlling signal with which a brightness of a display device is controlled, the image processing apparatus comprising:
a sensor configured to acquire first brightness data;
a receiver configured to receive second brightness data;
a correction coefficient calculator configured to calculate a correction coefficient based on the first brightness data and the second brightness data;
a parameter calculator configured to calculate a parameter based on the first brightness data and the correction coefficient;
a controller configured to control a brightness controlling signal according to a brightness value corresponding to the parameter; and
an output module configured to output the brightness controlling signal.

2. The image processing apparatus of claim 1,
wherein the sensor acquires the first brightness data according to light received in a same direction as the display panel of the display device, and
the receiver acquires the second brightness data calculated according to light received in a direction opposite to the display panel of the display device.

3. The image processing apparatus of claim 2,
wherein the correction coefficient calculator calculates the correction coefficient based on a ratio between the first brightness data and the second brightness data, and
the parameter calculator multiplies the first brightness data and the correction coefficient, and calculates the parameter.

4. The image processing apparatus of claim 1 further comprising:
a memory storing the correction coefficient, and
wherein when the second brightness data are not received by the receiver, the parameter calculator calculates the parameter based on the correction coefficient stored in the memory and the first brightness data.

5. The image processing apparatus of claim 1, wherein the controller receives the video signal for displaying a video on the display panel of the display device, and controls the brightness controlling signal and the video signal, according to the brightness value corresponding to the parameter.

6. The image processing apparatus of claim 2, wherein the receiver acquires the second brightness data calculated from an image in a region not including the display panel in a taken image in a range including the display panel of the display device.

7. A non-transitory computer readable medium having stored thereon a control program which is executable by a remote operation apparatus,
the remote operation apparatus comprising:
a communication module configured to communicate with an image processing apparatus outputting a brightness controlling signal with which a brightness of a display device is controlled; and
an image acquire module configured to acquire an image,
wherein the control program causes the remote operation apparatus to operate as:
a region extraction module configured to extract a region not including a display panel of the display device, from the image acquired by the image acquire module;
a brightness data calculator configured to calculate brightness data from the image in the extracted region; and
a controller configured to perform control so as to transmit the brightness data to the image processing apparatus using the communication module.

8. A controlling method for an image processing apparatus for outputting a brightness controlling signal for controlling a brightness of a display device, after acquiring first brightness data and second brightness data, the controlling method comprising:
calculating a correction coefficient based on the first brightness data and the second brightness data;
calculating a parameter based on the first brightness data and the correction coefficient;
controlling a brightness controlling signal according to a brightness value corresponding to the parameter; and
outputting the brightness controlling signal.
